(19) United States
(12) Patent Application Publication
(10) Pub. No.: US 2004/0240860 A1
(43) Pub. Date: Dec. 2, 2004

(54) Apparatus, a record carrier and a method for reproducing video data signals

(76) Inventors: Wilhelmus Hendrikus Alfonsus Bruls, Eindhoven (NL); Christiaan Edzard van Haersma Buma, Eindhoven (NL); Wiebe De Haan, Eindhoven (NL)

Correspondence Address: Philips Electronics North America Corporation, Corporate Patent Counsel, PO Box 3001, Briarcliff Manor, NY, 10510, US

(21) Appl. No.: 10/492,667

(22) PCT Filed: Oct. 21, 2002
(86) PCT No.: PCT/IB02/04324

(30) Foreign Application Priority Data
Oct. 19, 2001 (EP) 01402731.2

(51) Int. Cl. H04N 5/781

(52) U.S. Cl. 386/111; 386/125

(57) ABSTRACT

An apparatus for reproducing video data signals has been proposed. It comprises input means for receiving encoded video data signals and processing means for decoding the encoded video data signals into the video data signals. The encoded video data signals comprise a base stream of signals representing a standard resolution portion of the video data signals and at least one enhancement stream of signals representing a high-resolution portion of the video data signals. The apparatus is capable of reproducing high-resolution video data by decoding and combining those streams. Various measures in relation to storing the encoded video data on a record carrier are also proposed.

The invention relates to an apparatus for reproducing video data signals comprising:

input means for receiving encoded video data signals; and

processing means for decoding the encoded video data signals into the video data signals.

The invention also relates to a record carrier comprising encoded video data signals.

The invention further relates to a method of encoding video data signals.

In addition, the invention relates to a method of decoding video data signals.

Video signal processing systems that utilize storage media having digitally compressed (encoded) video and audio information recorded thereon can give a user a vast number of options for controlling presentation of a program, or a video title, stored on such media. One such system that is gaining rapid popularity comprises a video disc player adapted to process information stored on a DVD (Digital Video Disc or Digital Versatile Disc) record carrier. The current DVD standard supports video images of a maximum resolution of 720×576 lines at 25 Hz or 720×480 lines at 29.94 Hz as used by analog television standards PAL and NTSC, respectively. These television standards are commonly referred to as Standard Definition Television (SDTV).

Recently, digital television standards have been developed to transmit and process high quality video, audio and ancillary data. Among other things, they offer improved picture resolution of e.g. 1920×1080 lines or 1280×720 lines, referred to as High Definition Television (HDTV).

The international patent application WO 00/30358 discloses a method of storing HDTV signals on a DVD record carrier. However, if the same compression technology (MPEG-2) is used as in case of a standard DVD, i.e. a DVD containing SDTV information, compressed streams need to be encoded at a higher bitrate in order to be able to realize high quality video. This implies that with the same requirement for the playing time on one side of the optical DVD disc (135 minutes), the total storage capacity of the disc would have to increase. This would call for a complete technology shift in disc manufacturing as well as drive technology. As a side effect, backward compatibility with legacy players would become impossible.

Rather than improving the optical disc technology, the latest developments in video compression technology could be applied to achieve HDTV resolution video quality at the same bitrate as currently used on SDTV resolution dual-layer DVD discs. If this solution is taken, the HDTV discs can be produced using installed manufacturing processes. In addition, existing drives can be used in the players. The only things that need to be upgraded are the encoding systems in the authoring chain and the decoding chips for the players. Still, the resulting discs are not backward compatible with the installed base of DVD players.

It is an object of the invention to provide a system that allows both a standard resolution version of video data and a high-resolution version of the same video data to be efficiently processed in a manner that allows the standard resolution version to be compatible with the legacy of reproducing devices.

This object is achieved, according to a first aspect of the invention, by an apparatus of the type described in the opening paragraph, wherein the processing means are adapted to decode the encoded video data signals comprising a base stream of signals representing a standard resolution portion of the video data signals and at least one enhancement stream of signals representing a high-resolution portion of the video data signals, and to combine the standard definition portion and the high-resolution portion into the video data signals.

The apparatus according to the invention is advantageous in that it can reproduce high-resolution video data signals transmitted in an efficient manner together with standard resolution video data signals.

In an embodiment for the apparatus the processing means are adapted to decode the encoded video data signals wherein the base stream of signals and the at least one enhancement stream of signals are encoded using different encoding techniques. This embodiment is advantageous in that it gives more flexibility in processing video data signals: for example, for compatibility reasons the base stream can be encoded using MPEG-2 compression technique whereas enhancement streams can be encoded using more advanced methods.

In another embodiment of the apparatus the processing means are adapted to decode the encoded video data signals wherein the standard resolution portion of the video data signals are SDTV signals and the video data signals are HDTV signals. This embodiment is advantageous in that it can be used to reproduce both PAL/NTSC standard television video data as well as high-resolution standards defined by the Advanced Television Systems Committee (ATSC).

In a further embodiment of the apparatus the input means are adapted to receive the encoded video data signals from a record carrier comprising data tracks. This is advantageous in that it provides a convenient way of accessing the video data by the apparatus.

It is advantageous, if the processing means are adapted to decode the encoded video data signals wherein the base stream of signals and the at least one enhancement stream of signals are protected by different encryption techniques. This facilities a scheme of flexible digital rights management.

A further embodiment for the apparatus is characterized in that the input means are adapted to receive the base stream of signals interleaved with the at least one enhancement stream of signals. This embodiment is advantageous in that the base stream and enhancement streams can be accessed/processed in turns.

It is beneficial for the input means to be adapted to receive the encoded video data signals from a DVD optical disc. This allows for use of a medium (pre)recorded according to a common standard in high-resolution devices as well as in standard resolution devices.

In another embodiment of the apparatus the input means are adapted to receive the base stream of signals and the at least one enhancement stream of signals multiplexed within a MPEG stream. This makes it possible to simplify authoring and inputting of the video data received by the apparatus.

It is beneficial, if the input means are adapted to receive the base stream of signals and the at least one enhancement stream of signals multiplexed within the MPEG stream with muxrate always below 10.08 Mbps. This ensures that the legacy DVD players can properly processed the video data signals received from the same source as the apparatus.

In a following embodiment of the apparatus according to the invention, the input means are adapted to receive the base stream of signals and the at least one enhancement stream of signals comprised in separate data tracks on the record carrier. This embodiment is advantageous in that it provides a way of separating the base stream data and enhancement streams data on the record carrier.

In an advantageous embodiment the input means are adapted to receive the base stream of signals and the at least one enhancement stream of signals, wherein the separate data tracks are comprised in separate physical layers on the record carrier. This makes it possible to associate a particular stream of the video data (the base stream or the enhancement stream) with a specific physical layer of the record carrier.

According to a second aspect of the invention a record carrier of the type described in the opening paragraph is provided, wherein the encoded video data signals comprise a base stream of signals representing a standard resolution portion of the encoded video data signals and at least one enhancement stream of signals representing a high-resolution portion of the encoded video data signals.

According to a third aspect of the invention a method of encoding video data signals is provided comprising steps of:

encoding a base stream of signals representing a standard resolution portion of the video data signals;

encoding at least one enhancement stream of signals representing a high-resolution portion of the video data signals.

According to a forth aspect of the invention a method of decoding encoded video data signals is provided comprising steps of:

decoding a base stream of signals representing a standard resolution portion of the encoded video data signals;

decoding at least one enhancement stream of signals representing a high-resolution portion of the encoded video data signals.

These and other aspects of the invention will be further elucidated and described with reference to the drawings, in which:

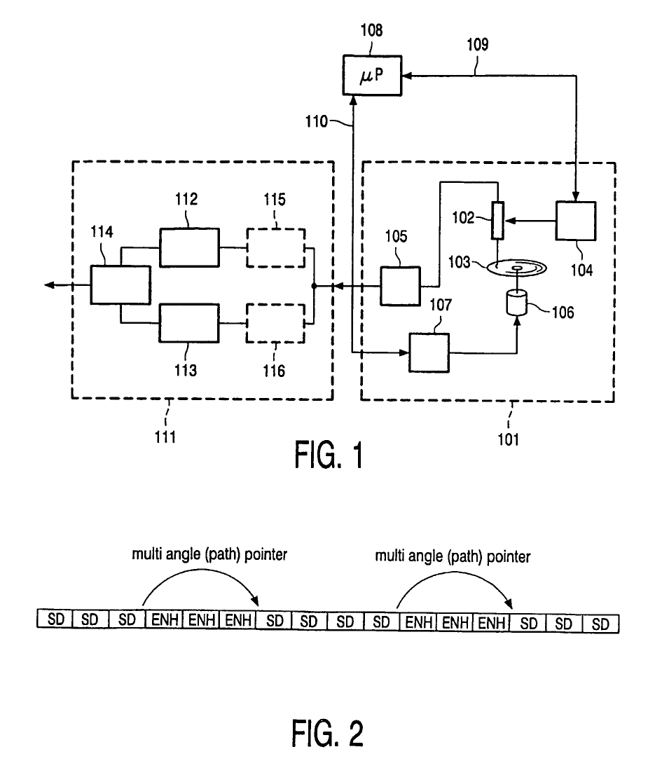

FIG. 1 shows an embodiment of an apparatus for reproducing video data signals, in accordance with the invention.

FIG. 2 illustrates interleaving of SD and ENH data by using multi angle (path) pointers.

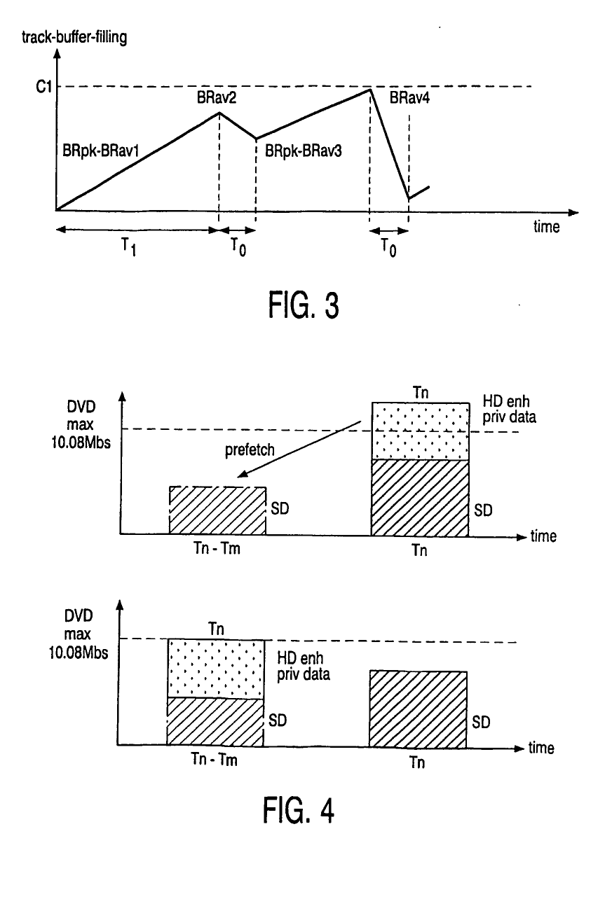

FIG. 3 shows filling of a track-buffer as a function of time.

FIG. 4 illustrates multiplexing of ENH data in the MPEG stream at an earlier time than the corresponding SD data.

FIG. 1 shows an embodiment of an apparatus for reproducing video data signals, in accordance with the invention. The apparatus comprises a read unit 101 for receiving encoded video data signals and a processing unit 111. The processing unit 111 receives the encoded video data signals from the read unit 101 and decodes them into the video data signals. The read unit 101 comprises a read head 102, which is in the present example an optical read head for reading the encoded video data signals from the record carrier 103. Further, positioning means 104 are present for positioning the head 102 in a radial direction across the record carrier 103. A read amplifier 105 is present in order to amplify the signal read from the record carrier 103. A motor 106 is available for rotating the record carrier 103 in response to a motor control signal supplied by a motor control signal generator unit 107. A microprocessor 108 is present for controlling all the circuits via control lines 109 and 110.

The processing unit 111 is adapted to decode the encoded video data signals comprising a base stream of signals representing a standard resolution portion of the video data signals and at least one enhancement stream of signals representing a high-resolution portion of the video data signals, and to combine the standard definition portion and the high-resolution portion into the video data signals. The base stream of signals is decoded by a base decoder 112, whereas the enhancement stream of signals is decoded by an enhancement decoder 113. The signals coming from decoders 112 and 113 are combined in a combining unit 114 to form the video data signals of high-resolution.

Thus, the processing unit 111 is performing, according to the invention, a method of decoding encoded video data signals, which comprises steps of:

decoding a base stream of signals representing a standard resolution portion of the encoded video data signals;

decoding at least one enhancement stream of signals representing a high-resolution portion of the encoded video data signals.

This method can be modified to include a step of de-multiplexing the base stream of signals and the at least one enhancement stream of signals from a MPEG stream.

The encoded video data signals, which are received by the input unit 101, are generated, according to the invention, by a method of encoding video data signals, which comprises steps of:

encoding a base stream of signals representing a standard resolution portion of the video data signals;

encoding at least one enhancement stream of signals representing a high-resolution portion of the video data signals.

This method can be applied for authoring DVD discs using a two (or more) stream approach with scalable compression, of which each compression stream is allocated on a disc separated from each other in such a way, that a standard DVD player can see only the first (basic) stream.

The encoding of video data signals can be modified to include a step of multiplexing the base stream of signals and the at least one enhancement stream of signals within a MPEG stream as explained later in the text.

Advantageously, the input unit 101 can be replaced by an input terminal to receive the encoded video data signals via a cable, Internet or a wireless link.

The processing unit 111 may comprise more than one decoder for decoding more than one enhancement stream; it may also comprise more than one combining unit. This allows for reproduction of the video data signals having variety of different resolutions.

An embodiment of the recording apparatus is realized by adapting the processing unit 111 to decode the encoded video data signals wherein the base stream of signals and the at least one enhancement stream of signals are encoded using different encoding techniques. For example the base stream can be encoded using MPEG-2 compression technique whereas enhancement streams can be encoded using more advanced methods. This solution provides backward compatibility with the legacy devices. At the same time enhancement streams can be transported with high efficiency.

In a particular implementation of the invention, the base decoder 112 is adapted to decode SDTV signals, the enhancement decoder 113 is adapted to decode HDTV surplus signals and the combining unit 114 is adapted to produce HDTV signals.

Advantageously, the read unit 101 can be adapted to receive the encoded video data signals from a DVD optical disc medium.

It is beneficial, if this type of a DVD disc is provided with video data in such a way that legacy DVD players can reproduce the base, Standard Definition (SD) part of video data as from ordinary DVD media. This can be achieved by separating the base data and the enhancement data (ENH) in a number of manners.

One possibility is to interleave these data at the level of video object files (VOBs) as known from the DVD standard. It is possible to use for this purpose multi (camera) angle pointers or multi path pointers. For example SD data may be comprised in default camera angle track and HD surplus data—in an alternate camera angle track. This is illustrated in FIG. 2. Every DVD player has a so-called track-buffer of C1 Mbits. The encoding and multiplexing of the SDTV stream must be done in such a way that at every separation point there are enough bits in the track-buffer to bridge the gap in time it takes to jump over a block of enhancement sectors. Suppose it takes T₀ seconds for a jump before new SD sectors are read again. During T₀ an average bitrate supplied to decoder is BRₐᵥ. This means that at least T₀ * BRₐᵥ bits must be present in the buffer at the moment of jump. The peak rate at which a DVD player can read is BRₚₖ. Reading should be perform at the maximum rate possible, BRₚₖ. During reading we also have to supply the decoder with the needed SD bits, so the track-buffer will grow with a rate BRₚₖ −BRₐᵥ . So generally, the bits build-up during reading the SD sectors, T1 * (BRₚₖ −BRₐᵥ₁ ), must much with the bits, T₀ * BRₐᵥ₂ , needed during the jump phase, as schematically shown in FIG. 3. This puts an additional constraint to the SD encoder; it must use this model and its parameters for the regulation of a bitrate and multiplexing.

The input unit 101 can be adapted to receive SD and ENH data streams which are interleaved on the record carrier 103 in the manner described above.

Another way to separate SD and ENH data is to store them on the record carrier 103 in separate files/tracks and adapt the input unit 101 accordingly. In this embodiment the input unit 101 is able to read a block (say for 1 second of video) of SD data very fast and put it in a memory, then jump to the HD surplus data area and read very fast a block (again, say for 1 second of video) of ENH data and put them in memory. In this way the drive keeps alternating reading the SD and ENH sectors. The base decoder 112 and the enhancement decoder 113 can read from this memory. The input unit 101 and the memory are made sufficiently fast and large so that decoders 112 and 113 never run of data and thus are able to deliver an uninterrupted continues HD video data signal. In this scheme, for the interval of 1 second about 2 MB of memory is required.

Furthermore, the input unit 101 can be adapted to recognize signaling bits which do not affect regular DVD players, but can be used to direct the apparatus, according to the invention, to reproduce high-resolution video data.

Yet another option is to put base data representing a standard resolution portion of the video data signals and enhancement data representing a high-resolution portion of the video data signals in different physical layers on the record carrier 103. In this case the input unit 101 is adapted to receive encoded video data signal from a multi-layer optical disc.

In addition to the above, there are other ways to separate SD and ENH data in a backward compatible way at the MPEG stream level:

at the MPEG-2 Program Stream level

at the MPEG-2 (or MPEG-1) elementary stream level.

At the MPEG-2 Program Stream level, the enhancement data can be multiplexed when it is included in a private stream. An embodiment on a DVD disc is to put the ENH data in MPEG private_stream_{—}1 packets with a DVD sub_stream_id that is currently reserved. Alternatively, the HD surplus data can be included in the MPEG-2 video elementary stream in extension_and-user_data segments, at a sequence, at group of pictures or at a picture level. A drawback of including the additional data directly into the MPEG stream is the DVD standard requirement to restrict the muxrate to 10.08 Mbps. Although the target average for the total data stream is about 8 Mbps (allowing for recording 135 minutes on a dual-layer DVD disc), peak rates can be well above the maximum. Legacy players might fall over if this maximum bitrate is exceeded. Therefore, the allocation rule for the ENH data should be relaxed in such a way that the excess data near the peak rates can be more evenly spread over a wider area in the stream. This can be accomplished by defining the size of the separate buffer, which is required for the ENH data stream in the MPEG-2 system target decoder model, big enough to handle the vast majority of streams. In exception cases peak bitrate problems can be solved by proper preprocessing (filtering) and/or by adjusting the compression rate locally. FIG. 4 shows an embodiment where the ENH data is mixed to an earlier time than the corresponding SD data. After readout by the input unit 101 this prefetched ENH data is kept in a ENH data memory 116 until it is needed by the enhancement decoder 113. Even when the average prefetch time offset is as much as 1 minute, the corresponding memory size is still very realistic (60 seconds * 2 Mbps <16 MB). In a particular embodiment a faster then 1× drive and optional SD data memory 115 is used.

Separating the SD and HD surplus streams at the MPEG level has a number of advantages:

authoring is relatively simple as the two streams are combined together at the MPEG level immediately after coding. Other stages of the authoring process are hardly affected.

the jump noise in the apparatus is kept low (compared with a solution where the streams are at a greater physical distance).

the MPEG stream including the ENH data can be redistributed without additional processing, using existing standards.

since this MPEG output stream more or less has a CBR behavior, it can be transmitted rather easily over a wireless link.

The enhancement data on the record carrier 103 should be protected by a different technique than the base data, so illegal copies of the record carrier 103 would have video data of worse quality.

Whilst the invention has been described with reference to preferred embodiments thereof, it is to be understood that these are not limitative examples. Thus, various modifications may become apparent to those skilled in the art, without departing from the scope of the invention, as defined by the claims. Further, the invention lies in each and every novel feature or combination of features described above. It is noted, that the invention may be implemented by means of a general purpose processor executing a computer program or by dedicated hardware or by a combination of both, and that in this document the word “comprising” does not exclude the presence of other elements or steps than those listed and the word “a” or “an” preceding an element does not exclude the presence of a plurality of such elements, that any reference signs do not limit the scope of the claims, that “means” may be represented by a single item or a plurality and that several “means” may be represented by the same item of hardware.

1. An apparatus for reproducing video data signals comprising:
input means for receiving encoded video data signals; and
processing means for decoding the encoded video data signals into the video data signals;
characterized in that the processing means are adapted to decode the encoded video data signals comprising a base stream of signals representing a standard resolution portion of the video data signals and at least one enhancement stream of signals representing a high-resolution portion of the video data signals, and to combine the standard definition portion and the high-resolution portion into the video data signals.

2. An apparatus as claimed in claim 1, characterized in that the processing means are adapted to decode the encoded video data signals wherein the base stream of signals and the at least one enhancement stream of signals are encoded using different encoding techniques.

3. An apparatus as claimed in claim 1, characterized in that the processing means are adapted to decode the encoded video data signals wherein the standard resolution portion of the video data signals are SDTV signals and the video data signals are HDTV signals.

4. An apparatus as claimed in claim 1, characterized in that the input means are adapted to receive the encoded video data signals from a record carrier comprising data tracks.

5. An apparatus as claimed in claim 4, characterized in that the processing means are adapted to decode the encoded video data signals wherein the base stream of signals and the at least one enhancement stream of signals are protected by different encryption techniques.

6. An apparatus as claimed in claim 4, characterized in that the input means are adapted to receive the base stream of signals interleaved with the at least one enhancement stream of signals.

7. An apparatus as claimed in claim 4, characterized in that the input means are adapted to receive the encoded video data signals from a DVD optical disc.

8. An apparatus as claimed in claim 4, characterized in that the input means are adapted to receive the base stream of signals and the at least one enhancement stream of signals multiplexed within a MPEG stream.

9. An apparatus as claimed in claim 7, characterized in that the input means are adapted to receive the base stream of signals and the at least one enhancement stream of signals multiplexed within the MPEG stream with muxrate always below 10.08 Mbps.

10. An apparatus as claimed in claim 4, characterized in that the input means are adapted to receive the base stream of signals and the at least one enhancement stream of signals comprised in separate data tracks on the record carrier.

11. An apparatus as claimed in claim 10, characterized in that the input means are adapted to receive the base stream of signals and the at least one enhancement stream of signals, wherein the separate data tracks are comprised in separate physical layers on the record carrier.

12. A record carrier comprising encoded video data signals comprising a base stream of signals representing a standard resolution portion of the encoded video data signals and at least one enhancement stream of signals representing a high-resolution portion of the encoded video data signals.

13. A record carrier as claimed in claim 12, characterized in that the record carrier is a DVD optical disc.

14. A record carrier as claimed in claim 12, characterized in that the base stream of signals and the at least one enhancement stream of signals are encoded using different encoding techniques.

15. A record carrier as claimed in claim 12, characterized in that the standard resolution portion of the encoded video data signals are SDTV signals and the encoded video data signals are HDTV signals.

16. A record carrier as claimed in claim 12, characterized in that the base stream of signals and the at least one enhancement stream of signals are protected by different encryption techniques.

17. A record carrier as claimed in claim 12, characterized in that the base stream of signals is interleaved with the at least one enhancement stream of signals.

18. A record carrier as claimed in claim 12, characterized in that the base stream of signals and the at least one enhancement stream of signals are multiplexed within a MPEG stream.

19. A record carrier as claimed in claim 12, characterized in that the base stream of signals and the at least one enhancement stream of signals are comprised in separate data tracks.

20. A record carrier as claimed in claim 19, characterized in that the separate data tracks are comprised in separate physical layers.

21. A method of encoding video data signals comprising steps of:
encoding a base stream of signals representing a standard resolution portion of the video data signals;
encoding at least one enhancement stream of signals representing a high-resolution portion of the video data signals.

22. A method as claimed in claim 21, characterized in that the standard resolution portion of the video data signals are SDTV signals and the video data signals are HDTV signals.

23. A method as claimed in claim 21, comprising a step of:
multiplexing the base stream of signals and the at least one enhancement stream of signals within a MPEG stream.

24. A method of decoding encoded video data signals comprising steps of:
decoding a base stream of signals representing a standard resolution portion of the encoded video data signals;
encoding at least one enhancement stream of signals representing a high-resolution portion of the encoded video data signals.

25. A method as claimed in claim 24, characterized in that the standard resolution portion of the encoded video data signals are SDTV signals and the encoded video data signals are HDTV signals.

26. A method as claimed in claim 24, comprising a step of:
de-multiplexing the base stream of signals and the at least one enhancement stream of signals from a MPEG stream.
